(19) United States
(12) Patent Application Publication
(10) Pub. No.: US 2025/0382999 A1
(43) Pub. Date: Dec. 18, 2025

(54) BRAKING ASSEMBLY, BRAKE DISC, AND WHEEL

(71) Applicant: Poli S.r.L., Camisano (CR) (IT)

(72) Inventors: Marco CREMONA, Vailate (CR) (IT); Angelo D'ANGELO, Crema (CR) (IT); William DEZIO, Zanica (BG) (IT); Nino RONCHI, Vaprio D’Adda (MI) (IT)

(73) Assignee: Poli S.r.L., Camisano (CR) (IT)

(21) Appl. No.: 19/242,075

(22) Filed: Jun. 18, 2025

(30) Foreign Application Priority Data
Jun. 18, 2024 (IT) 102024000013882

(51) Int. Cl. F16D 65/12; F16D 55/00; F16D 65/02

(52) U.S. Cl. CPC F16D 65/124; F16D 2055/0008; F16D 2065/1316; F16D 2065/1392

(57) ABSTRACT

A braking assembly for a wheel includes a first brake disc and a fastener system. The first brake disc is arranged to be coupled to a first side of the wheel and has a first wheel coupling face. The first brake disc defines a first through-hole having a first flared inner portion towards the wheel coupling face. The fastener system includes a first tapered portion that is complementary to the first flared inner portion and configured to abut the first flared inner portion when the fastener system is disposed in the first through-hole to couple the first brake disc to the first side of the wheel.

### CROSS-REFERENCE TO RELATED APPLICATION

This application claims priority and the benefit of Italian Patent Application No. 102024000013882, filed Jun. 18, 2024, entitled BRAKING ASSEMBLY, BRAKE DISC, AND WHEEL, the entire disclosure of which is incorporated herein by reference.

### FIELD OF THE INVENTION

The present invention relates, in general, to the field of brakes for vehicles. In particular, aspects of the invention relate to braking assemblies, brake discs, and wheels.

### DISCUSSION OF ART

Usually, braking assemblies are coupled to a wheel by means of fastening elements with traditional counterbores. In addition to braking assemblies having fastening elements with traditional counterbores, braking assemblies are also known which have fastening elements with undercut counterbores. An example of a braking assembly with fastening elements with undercut counterbores may, for example, be seen in EP2715180.

The various braking assemblies made according to the known art described above, due to the counterbores used, have a poor distribution of the clamping force when coupled to a wheel. Therefore, it may be desirable to provide a braking assembly that differs from existing brake assemblies.

### BRIEF DESCRIPTION

A braking assembly for a wheel includes a first brake disc and a fastener system. The first brake disc is arranged to be coupled to a first side of the wheel and has a first wheel coupling face. The first brake disc defines a first through-hole having a first flared inner portion towards the wheel coupling face. The fastener system includes a first tapered portion that is complementary to the first flared inner portion and configured to abut the first flared inner portion when the fastener system is disposed in the first through-hole to couple the first brake disc to the first side of the wheel.

### BRIEF DESCRIPTION OF THE FIGURES

The functional and structural features of some embodiments of the invention will now be described. Reference is made to the accompanying drawings, in which:

FIG. 1 is a sectional view of an embodiment of a braking assembly according to the present invention;

FIG. 2 shows, in detail, a section of the through-hole of the first brake disc illustrated in FIG. 1;

FIG. 3 shows in section a further embodiment of a braking assembly according to the present invention;

FIG. 4 shows in section a further embodiment of a braking assembly according to the present invention;

FIG. 5 shows in section a further embodiment of a braking assembly according to the present invention;

FIG. 6a shows in section a further embodiment of a braking assembly according to the present invention;

FIG. 6b shows in section a further embodiment of a braking assembly according to the present invention;

FIG. 6c shows in section a further embodiment of a braking assembly according to the present invention;

FIG. 7 is a sectional view of an embodiment of a brake disc according to the present invention;

FIG. 8 is a side sectional view of an embodiment of a wheel according to the present invention; and

FIG. 9 is a perspective view of the wheel of FIG. 8.

### DETAILED DESCRIPTION

Before explaining in detail a plurality of embodiments of the invention, it should be noted that the invention is not limited in its application to the construction details and the configuration of the components shown in the following description or illustrated in the drawings. The invention is capable of assuming other embodiments and of being implemented or practically made in various ways. It must also be understood that the phraseology and terminology have a descriptive purpose and should not be construed as limiting. The use of “include,” “having,” “comprise” and their variations are to be understood as including the elements listed hereafter and their equivalents, as well as additional elements and their equivalents.

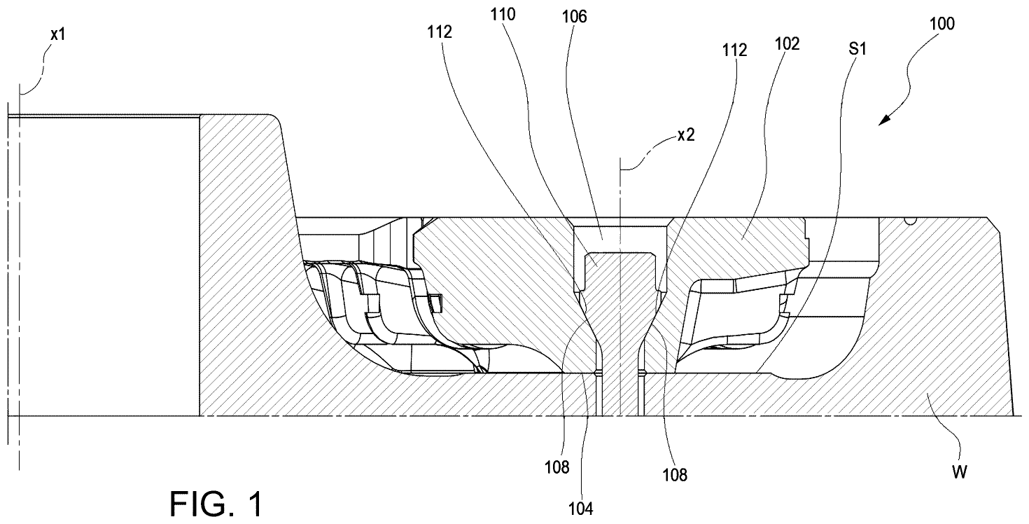

With initial reference to FIG. 1, an embodiment of a braking assembly 100 for a wheel W, e.g., a railway wheel, is described in detail below.

As shown in FIG. 1, the braking assembly 100 includes at least a first brake disc 102 having a brake disc body (e.g., circular metal body having a diameter and a thickness that is less than the diameter) and a central axis x1. The first brake disc 102 is furthermore arranged to be coupled to a first side S1 of the wheel.

The first brake disc 102 includes a wheel coupling face 104 and defines at least one through-hole 106 along an axis x2. The axis x2 is parallel to the central axis x1 of the first brake disc 102.

For example, as observable in FIG. 1, on the face of the brake disc opposite the wheel coupling face 104, one or more protruding fins may be present, suitable for directing air and promoting the cooling of the brake disc.

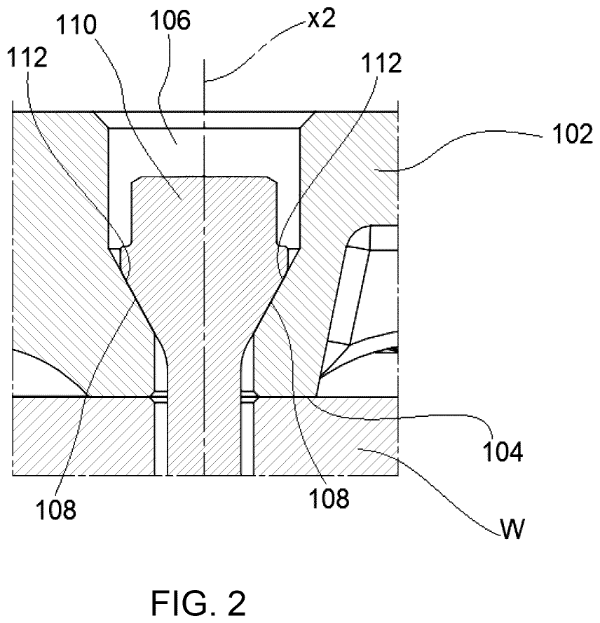

As observable in detail in FIG. 2, the at least one through-hole 106 defined by the first brake disc 102 includes at least one flared inner portion 108 towards the wheel coupling face 104.

As observable in the figures, by “flared towards the wheel coupling face 104” it can be understood that the diameter of the flared inner portion 108 decreases as it approaches the wheel coupling face 104. For example, the flared inner portion (and the tapered portion(s) of the fastener system) may be frustoconical in shape.

For example, the flared inner portion 108 may be only a part of the inner portion of the through-hole. For example, the flared inner portion 108 may be about one third of the total extension of the inner portion of the through-hole.

With further reference to FIG. 1, the braking assembly 100 also includes at least one fastening means (or fastening system) 110. The fastening means 110 includes a first tapered portion 112, complementary to the flared inner portion 108 defined by the through-hole 106 of the first brake disc 102.

The first tapered portion 112 of the fastening means 110 is arranged to abut the flared inner portion 108 defined by the through-hole 106 of the first brake disc 102, when the first brake disc 102 is coupled to the first side S1 of the wheel W.

In general, when the first brake disc 102 is coupled to the wheel W by the fastening means 110, thanks to the contact between the first tapered portion 112 of the fastening means 110 and the flared inner portion 108 of the through-hole 106 of the first brake disc 102, it may be possible to achieve a better distribution of the clamping force in the braking assembly coupled to the wheel, the force being distributed over a wider surface of the fastening element 110 for the same thread diameter compared to a standard fastening element.

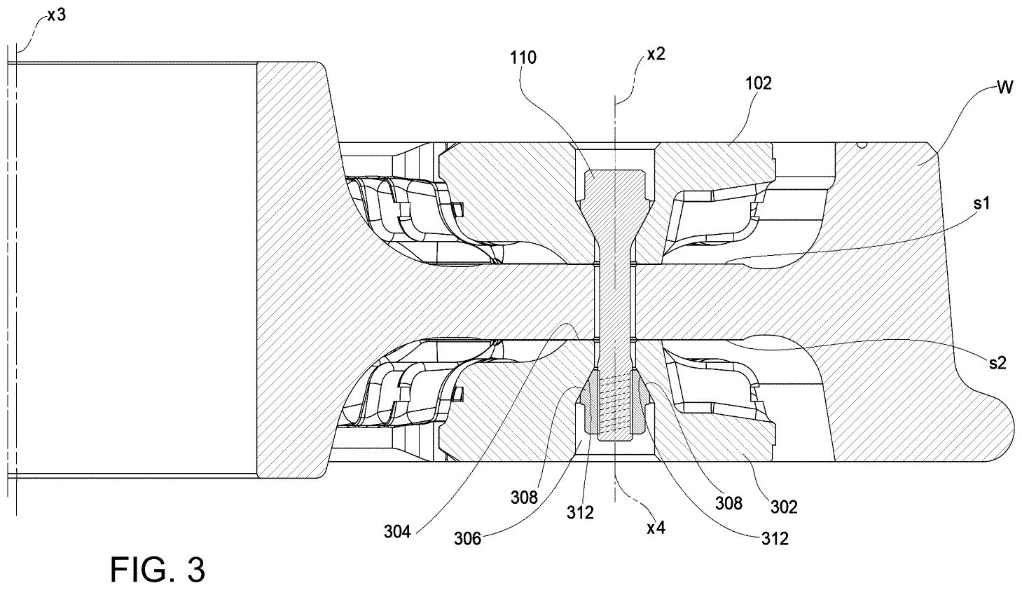

As for example observable in FIG. 3, the braking assembly may include at least a second brake disc 302 having a second brake disc body (e.g., circular metal body having a diameter and a thickness that is less than the diameter) and a central axis x3.

The second brake disc 302 may be configured to be coupled to a second side S2 of the wheel, opposite the first side S1 of the wheel.

The second brake disc 302 may include a wheel coupling face 304 and define at least one through-hole 306 along an axis x4 parallel to the central axis x3 of the second brake disc 302.

As may be understood from the figures, the axis x1 of the first brake disc 102 and the axis x3 of the second brake disc 302 may be coincident (i.e., aligned with one another). Furthermore, also the axis x2 of the through-hole 106 of the first brake disc 102 and the axis x4 of the through-hole 306 of the second brake disc 302 may be coincident (i.e., aligned with one another).

The through-hole 306 defined by the second brake disc 302 may include at least one flared inner portion 308 towards the wheel coupling face 304 of the second brake disc 302.

As observable in the figures, by “flared towards the wheel coupling face 304 of the second brake disc 302” it can be understood that the diameter of the flared inner portion 308 decreases as it approaches the wheel coupling face 304 of the second brake disc 302. For example, the flared inner portion 308 (and the tapered portions(s) of the fastener system) may be frustoconical in shape.

Furthermore, the at least one fastening means 110 may include a second tapered portion 312, complementary to the flared inner portion 308 defined by the through-hole 306 of the second brake disc 302.

The second tapered portion 312 of the fastening means 110 may be arranged to abut the flared inner portion 308 of the through-hole 306 of the second brake disc 302, when the second brake disc 302 is coupled to the second side S2 of the wheel.

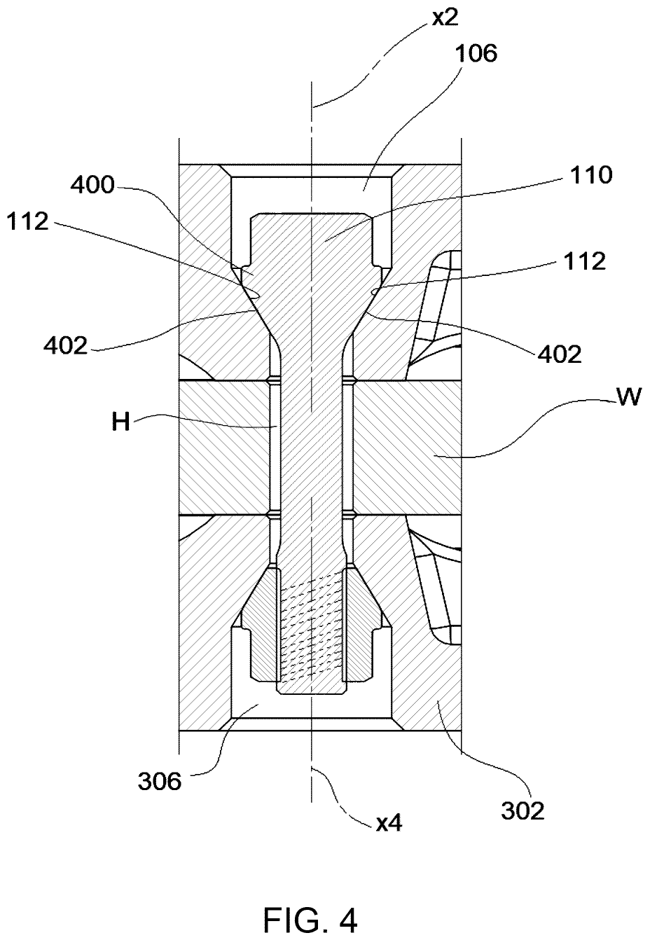

In embodiments, as observable in FIG. 4, the fastening means 110 may include a bolt. In this case, the first tapered portion 112 of the fastening means 110 may be a tapered portion 402 of a head 400 of the bolt, for example, an outer tapered portion 402 of a head 400 of the bolt.

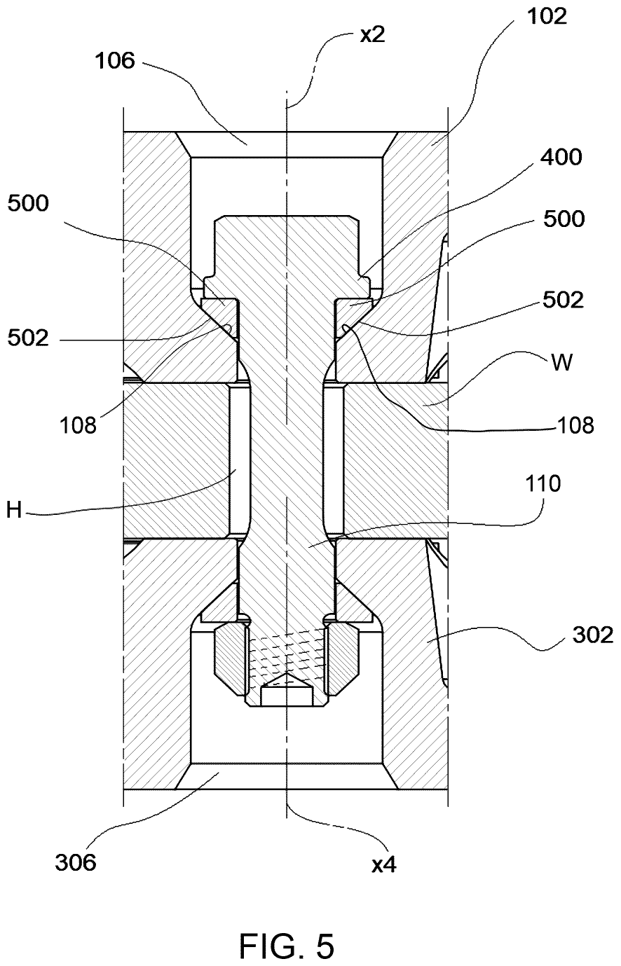

In an alternative, as observable in FIG. 5, the fastening means 110 may include a bolt and at least one spacer element 500 arranged to be placed between a head 400 of the bolt and the flared inner portion 108 of the first brake disc 102. In this case, the first tapered portion 112 of the fastening means 110 may be a tapered portion 502 of the spacer element 500, for example, an outer tapered portion 502 of the spacer element 500.

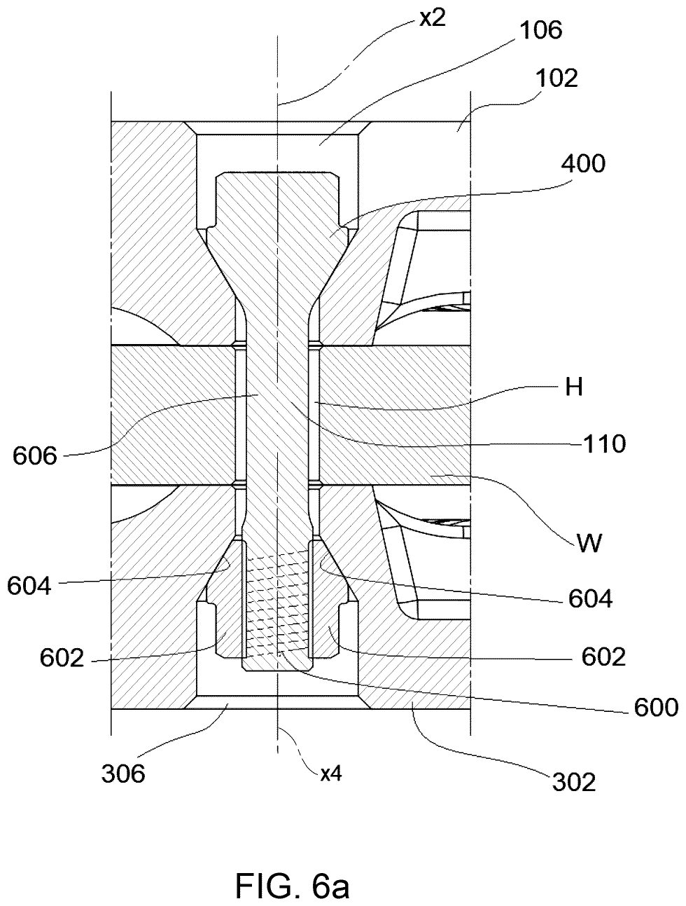

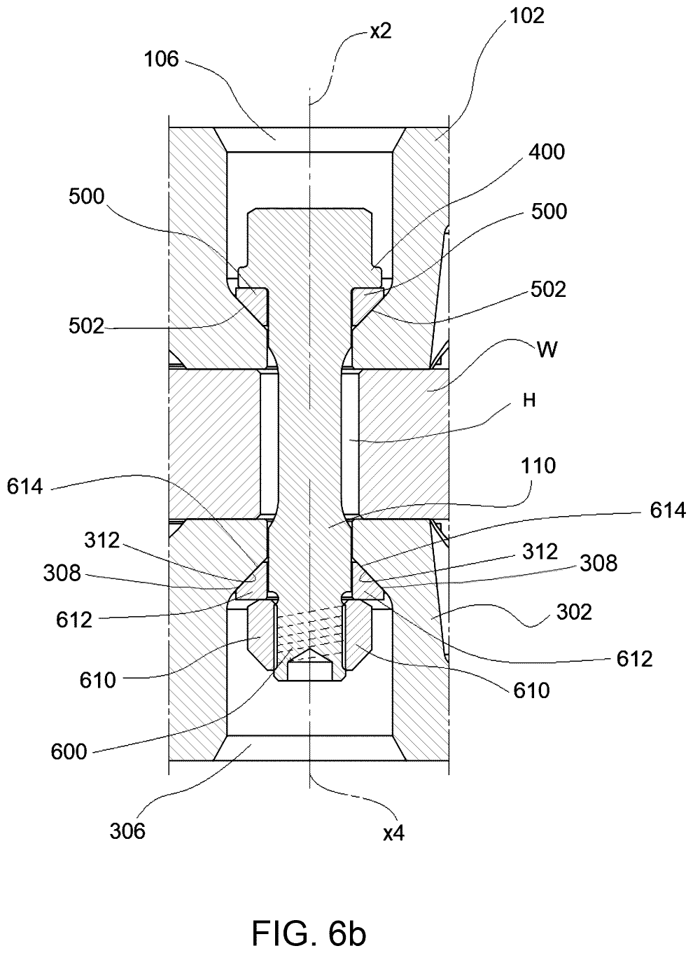

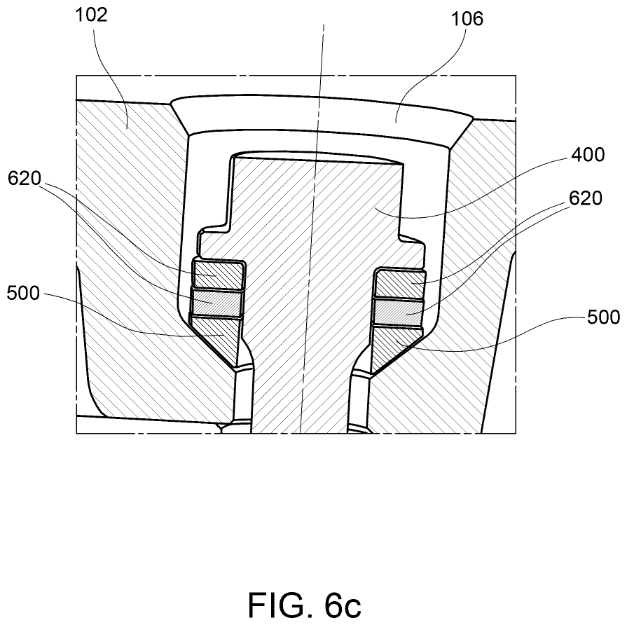

In embodiments, as observable in FIG. 6a, when the fastening means 110 includes a bolt, the bolt may include a first end (to which the head of the bolt is attached) and a threaded, second end 600, arranged opposite the head 400 of the bolt. In this case, the fastening means 110 may further include a nut 602 arranged to be screwed onto the threaded end 600, so as to couple the second brake disc 302 to the second side S2 of the wheel W. The second tapered portion 312 of the fastening means 110 may be a tapered portion 604 of the nut 602, for example, an outer tapered portion 604 of the nut 602.

In embodiments, in an alternative observable in FIG. 6b, when the fastening means 110 includes a bolt, the bolt may include a threaded end 600, arranged opposite the head 400 of the bolt. In this case, the fastening means 110 may further include a nut 610 arranged to be screwed onto the threaded end 600, so as to couple the second brake disc 302 to the second side S2 of the wheel W, and at least one second spacer element 612 arranged to be placed between the nut 610 and the flared inner portion 308 of the second brake disc 302. The second tapered portion 312 of the fastening means 110 may be a tapered portion 614 of the at least one second spacer element 612.

For example, a spacer element 500, 612 may be a washer or other spacer.

In a further implementation example not illustrated in the figures, when the fastening means includes a bolt, the bolt may include a groove arranged on one end of the bolt opposite the head of the bolt. The fastening means may further include a bush arranged to be shape-coupled or snap-fitted with the groove, so as to couple the second brake disc to the second side of the wheel. For example, the portion of the bush adapted to engage with the groove may be a rib radially projecting toward the central axis of the bush. The fastening means may further include a second spacer element arranged to be placed between the bush of the bolt and the flared inner portion of the second brake disc. The second tapered portion of the fastening means may be a tapered portion 614 of the second spacer element 612, for example, an outer tapered portion 614 of the second spacer element 612.

As for example observable in FIG. 6a, the fastening means 110 may include an intermediate portion 606 arranged to be housed in a through-hole H defined by the wheel W, when the first brake disc 102 is coupled to the first side S1 of the wheel W and/or the second brake disc 302 is coupled to the second side S2 of the wheel W.

As may be understood from the figures, the through-hole H may have a central axis coinciding with the axis x2 of the through-hole 106 of the first brake disc 102 and the axis x4 of the through-hole 306 of the second brake disc 302.

In embodiments, as observable in FIG. 6c, the braking assembly may include first elastic means, for example at least two disc springs 620, arranged to be placed between the head 400 of the bolt and the at least one spacer element 500.

In embodiments, the braking assembly may include second elastic means, for example again two disc springs, arranged to be placed between the nut 602, 610 and the at least one second spacer element 612.

For example, the two disc springs may be arranged in series or in parallel with one another.

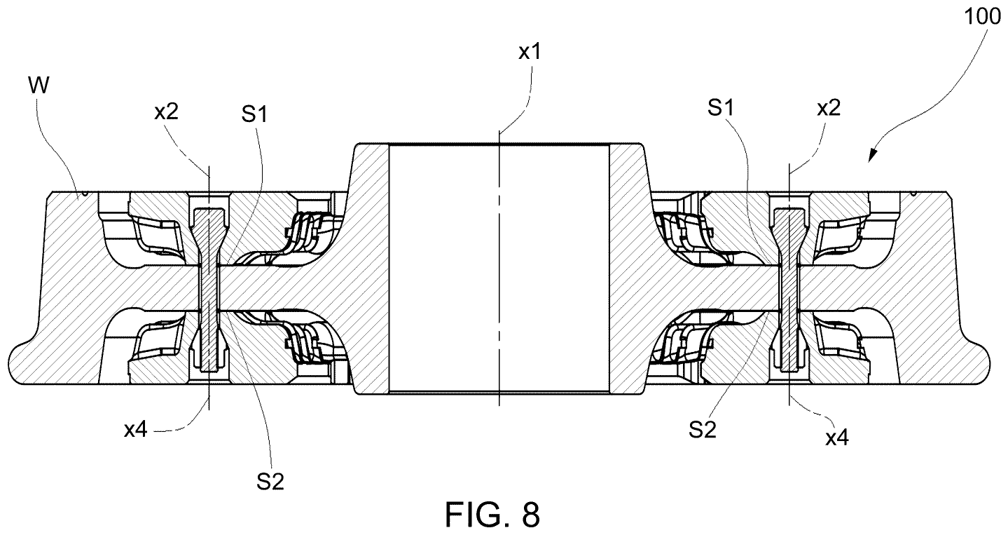

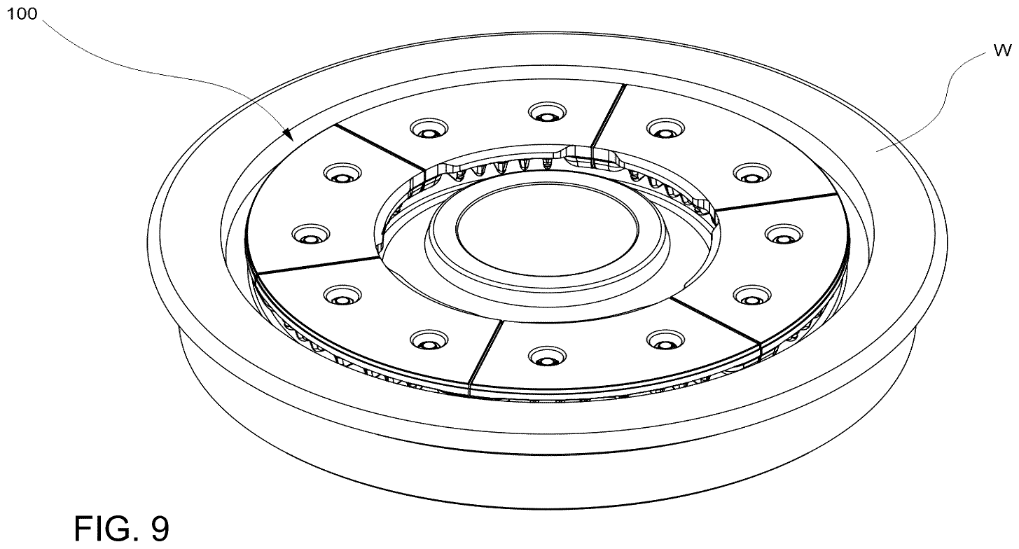

In a further aspect, embodiments of the invention relate to a wheel W. As observable in FIG. 8 and in FIG. 9, the wheel W includes a first side S1, a second side S2, and a braking assembly 100 according to any one of the embodiments described herein.

In embodiments, the wheel W may be a railway wheel.

In another aspect, embodiments of the invention relate to a vehicle (e.g., a rail vehicle) having a wheel and a braking assembly, as described herein, connected to the wheel.

In a further aspect, embodiments of the invention relate to a brake disc 700.

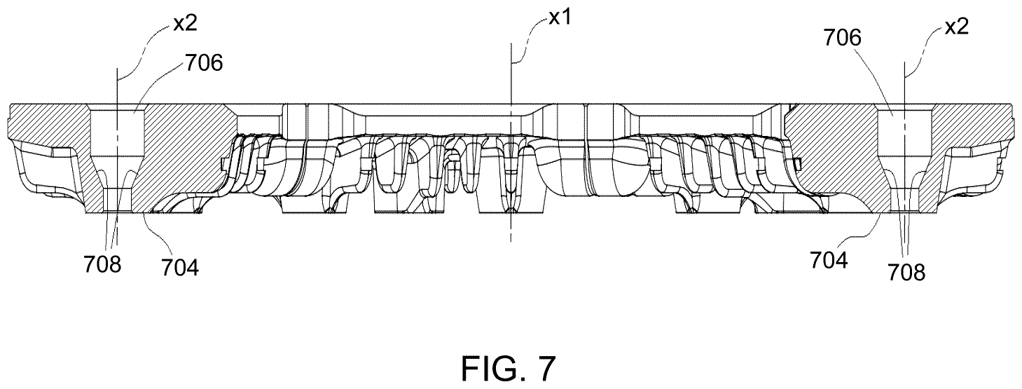

As for example observable in FIG. 7, the brake disc 700 has a brake disc body and a central axis x1. The brake disc body includes a wheel coupling face 704 and at least one through-hole 706 along an axis x2 parallel to the central axis x1 of the brake disc. The through-hole 706 includes at least one flared inner portion 708 towards the wheel coupling face 704.

For example, the brake disc 700 may be made of steel or cast-iron alloys.

In embodiments, the through-hole 706 of the brake disc 700 may be made at a braking/friction surface of the disc.

In one embodiment, the braking assembly 100 for a railway wheel W includes:
a first brake disc 102 arranged to be coupled to a first side S1 of the wheel W and defining a first through-hole 106 along an axis x2 parallel to the central axis x1 of the first brake disc 102 and having a first flared inner portion 108;
a second brake disc 302 arranged to be coupled to a second side S2 of the wheel W and defining a second through-hole 306 along an axis x4 parallel to the central axis x3 of the second brake disc 302 and having a second flared inner portion 308;
a bolt assembly, or called bolt group 110, 400, 500, having a first tapered portion 112, 402, 502 complementary to the first flared inner portion 108 and arranged to abut the first flared inner portion 108 when the first brake disc 102 is coupled to the wheel W; and
a nut 110, 602 having a second tapered portion 312, 604 complementary to the second flared inner portion 308 and arranged to abut the second flared inner portion 308 when the second brake disc 302 is coupled to the wheel, wherein the nut 110, 602 is configured to engage a threaded end 600 of the bolt assembly to affix the first and second brake discs 102, 103 to the wheel W.

In embodiments, the bolt assembly 110, 400, 500 may include an intermediate portion 606 extending between the first tapered portion 112, 402, 502 and the second tapered portion 312, 604, and wherein the intermediate portion 606 is arranged to be housed in a through-hole H defined by the wheel W when the first brake disc 102 is coupled to the first side S1 of the wheel W and/or the second brake disc 302 is coupled to the second side S2 of the wheel W.

In embodiments, the through-hole H of the wheel W, the first through-hole 106, and the second through-hole 306 may be concentric.

In embodiments, the first tapered portion 112, 402, 502 may be a tapered portion 402 of a head 400 of the bolt assembly 110, 400, 500.

In embodiments, the first tapered portion 112, 402, 502 may be a tapered portion 502 of a spacer element 500, and wherein the spacer element 500 is arranged to be disposed between the head 400 of the bolt assembly 110, 400, 500 and the first flared inner portion 108 of the first brake disc 102.

In an embodiment, a braking assembly for a wheel includes a first brake disc and a fastener system. The first brake disc is arranged to be coupled to a first side of the wheel and has a first wheel coupling face. The first brake disc defines a first through-hole having a first flared inner portion towards the wheel coupling face. The fastener system includes a first tapered portion that is complementary to the first flared inner portion and configured to abut the first flared inner portion when the fastener system is disposed in the first through-hole to couple the first brake disc to the first side of the wheel.

In another embodiment, the fastener system includes a bolt having a shaft and a head, wherein the head of the bolt includes the first tapered portion.

In another embodiment, the fastener system includes a bolt and a spacer element arranged to be placed between a head of the bolt and the first flared inner portion of the first brake disc. The spacer element includes the first tapered portion.

In another embodiment, the braking assembly further includes a second brake disc arranged to be coupled to a second side of the wheel opposite the first side of the wheel. The second brake disc includes a second wheel coupling face and defines a second through-hole having a second flared inner portion towards the second wheel coupling face. The fastener system further includes a second tapered portion complementary to the second flared inner portion and arranged to abut the second flared inner portion when the fastener system is disposed in the second through-hole to couple the second brake disc to the second side of the wheel.

In another embodiment, the fastener system includes a bolt and a nut. The bolt has a shaft and a head, the shaft having a first end and a threaded, second end. The head is attached to the first end of the shaft and includes the first tapered portion. The nut is configured to be screwed onto the threaded second end, so as to couple the second brake disc to the second side of the wheel, and wherein the nut comprises the second tapered portion.

In another embodiment, the fastener system includes a bolt and a nut. The bolt has a shaft and a head, the shaft having a first end and a threaded, second end. The head is attached to the first end of the shaft and includes the first tapered portion. The nut is configured to be screwed onto the threaded second end, so as to couple the second brake disc to the second side of the wheel. The fastener system further includes a second spacer element configured to be placed between the nut and the second flared inner portion, wherein the second spacer element includes the second tapered portion.

In an embodiment, a braking assembly for a wheel includes a first brake disc, a second brake disc, and a fastener system. The first brake disc is arranged to be coupled to a first side of the wheel and includes a first wheel coupling face. The first brake disc defines a first through-hole having a first flared inner portion towards the wheel coupling face. The second brake disc is arranged to be coupled to a second side of the wheel opposite the first side of the wheel, and includes a second wheel coupling face and defines a second through-hole having a second flared inner portion towards the second wheel coupling face. The fastener system includes a first tapered portion that is complementary to the first flared inner portion and configured to abut the first flared inner portion when the fastener system is disposed in the first through-hole to couple the first brake disc to the first side of the wheel, and a second tapered portion complementary to the second flared inner portion and arranged to abut the second flared inner portion when the fastener system is disposed in the second through-hole to couple the second brake disc to the second side of the wheel. The fastener system may include one or more of: a bolt with a shaft, a head attached to a first end of the shaft, and a threaded portion on a second end of the shaft; a nut configured to screw onto the threaded end of the bolt; and one or more spacer elements. One or more of the bolt head, the nut, and/or the spacer elements may include the first and second tapered portions.

In an embodiment, a vehicle includes a wheel and a braking assembly attached to the wheel. The braking assembly includes first brake disc, a second brake disc, and a fastener system. The first brake disc is coupled to a first side of the wheel and includes a first brake disc body having a first wheel coupling face abutting the first side of the wheel. The first brake disc body defines a first through-hole having a first flared inner portion towards the first wheel coupling face. The second brake disc is coupled to a second side of the wheel opposite the first side of the wheel, and includes a second brake disc body defining a second wheel coupling face abutting the second side of the wheel. The second brake disc body defines a second through-hole having a second flared inner portion towards the second wheel coupling face. The fastener system is disposed in the first through-hole to couple the first brake disc body to the first side of the wheel and the second brake disc body to the second side of the wheel. The fastener system includes a first tapered portion that is complementary to the first flared inner portion and that abuts the first flared inner portion, and a second tapered portion complementary to the second flared inner portion and that abuts the second flared inner portion. The fastener system may include one or more of: a bolt with a shaft, a head attached to a first end of the shaft, and a threaded portion on a second end of the shaft; a nut configured to screw onto the threaded end of the bolt; and one or more spacer elements. One or more of the bolt head, the nut, and/or the spacer elements may include the first and second tapered portions.

In an embodiment, a brake disc includes a brake disc body having a central axis, a wheel coupling face, and at least one through-hole in the body along an axis parallel to the central axis. The through-hole includes at least one flared inner portion towards the wheel coupling face. The flared inner portion is configured to abut a complementary tapered portion of a fastener used to attach the brake disc body to a wheel.

Embodiments of the invention are applicable to the railway transport sector. Other embodiments are applicable to any further transport sector, for example to the road wheeled transport sector or metropolitan transport.

Aspects of the invention may involve achieving a better distribution of the forces in a braking assembly coupled to a wheel.

As used herein, unless otherwise specified, “brake disc” includes (i) a unitary brake disc having a single body (e.g. metal body) defining 360 degrees of unitary brake surface around a wheel central axis (e.g., a calliper-driven brake pad would be pressed against the unitary brake surface to cause slowing of the brake disc and thereby wheel, via friction) and (ii) a section of a segmented brake disc having plural such sections separate from one another, each an arcuate body (e.g., arcuate metal body) individually defining less than 360 degrees of a brake surface but together which, when coupled together to a wheel, define a total of 360 degrees of brake surface (see FIG. 9, for example) (e.g., a calliper-driven brake pad would be pressed against the combined brake surface to cause slowing of the brake disc and thereby wheel, via friction). For example, a segmented brake disc may be similar to a unitary brake disc but in effect divided into separate arcuate segments configured to be separately attached to a wheel, where once attached the combined segments define a 360 degree braking surface around the vehicle wheel axis/axle. In either case, a brake disc may include a brake disc body, e.g., a circular metal body having a diameter and a thickness that is less than the diameter or an arcuate metal body having an effective diameter (diameter corresponding to the arcuate shape) and a thickness that is less than the effective diameter.

Various aspects and embodiments of a braking assembly, a brake disc, and a wheel according to the invention have been described. It is intended that each embodiment may be combined with any other embodiment. The invention is also not limited to the described embodiments but may be varied within the scope defined by the appended claims.

1. A braking assembly for a wheel, comprising:
a first brake disc arranged to be coupled to a first side of the wheel and comprising a first wheel coupling face, wherein the first brake disc defines a first through-hole having a first flared inner portion towards the wheel coupling face; and
a fastener system comprising a first tapered portion, wherein the first tapered portion is complementary to the first flared inner portion and configured to abut the first flared inner portion when the fastener system is disposed in the first through-hole to couple the first brake disc to the first side of the wheel.

2. The braking assembly of claim 1, wherein the fastener system comprises a bolt having a shaft and a head, wherein the head of the bolt includes the first tapered portion.

3. The braking assembly of claim 1, wherein the fastener system comprises a bolt and a spacer element arranged to be placed between a head of the bolt and the first flared inner portion of the first brake disc, and wherein the spacer element includes the first tapered portion.

4. The braking assembly of claim 1, further comprising:
a second brake disc arranged to be coupled to a second side of the wheel opposite the first side of the wheel, wherein the second brake disc comprises a second wheel coupling face and defines a second through-hole having a second flared inner portion towards the second wheel coupling face;
wherein the fastener system further comprises a second tapered portion complementary to the second flared inner portion and arranged to abut the second flared inner portion when the fastener system is disposed in the second through-hole to couple the second brake disc to the second side of the wheel.

5. The braking assembly of claim 4, wherein the fastener system comprises a bolt and a nut, the bolt having a shaft and a head, the shaft having a first end and a threaded, second end, wherein the head is attached to the first end of the shaft and includes the first tapered portion, and wherein the nut is configured to be screwed onto the threaded second end, so as to couple the second brake disc to the second side of the wheel, and wherein the nut comprises the second tapered portion.

6. The braking assembly of claim 4, wherein the fastener system comprises a bolt and a nut, the bolt having a shaft and a head, the shaft having a first end and a threaded, second end, wherein the head is attached to the first end of the shaft and includes the first tapered portion, and wherein the nut is configured to be screwed onto the threaded second end, so as to couple the second brake disc to the second side of the wheel, and
wherein the fastener system further comprises a second spacer element configured to be placed between the nut and the second flared inner portion, wherein the second spacer element comprises the second tapered portion.

7. A braking assembly for a wheel, comprising:
at least a first brake disc having a central axis and configured to be coupled to a first side of the wheel, wherein the first brake disc comprises a first brake disc body having a first wheel coupling face and defining at least one first through-hole along an axis parallel to the central axis of the first brake disc, and wherein the first through-hole includes at least one first flared inner portion towards the first wheel coupling face; and
at least one fastening means comprising a first tapered portion, complementary to the first flared inner portion of the first through-hole of the first brake disc, wherein the first tapered portion of the fastening means is arranged to abut the first flared inner portion of the first through-hole of the first brake disc body when the first brake disc body is coupled to the first side of the wheel.

8. The braking assembly of claim 7, further comprising at least a second brake disc having a central axis and arranged to be coupled to a second side of the wheel opposite the first side of the wheel,
wherein the second brake disc comprises second brake disc body having a second wheel coupling face and defining at least one second through-hole along an axis parallel to the central axis of the second brake disc,
wherein the second through-hole includes at least one second flared inner portion towards the second wheel coupling face of the second brake disc,
wherein the at least one fastening means comprises a second tapered portion, complementary to the second flared inner portion,
wherein the second tapered portion of the fastening means is arranged to abut the second flared inner portion of the second through-hole of the second brake disc, when the second brake disc is coupled to the second side of the wheel.

9. The braking assembly of claim 8, wherein the fastening means comprises a bolt having a head, the head including the first tapered portion of the fastening means.

10. The braking assembly of claim 8, wherein the fastening means comprises a bolt and at least one spacer element arranged to be placed between a head of the bolt and the first flared inner portion of the first brake disc,
and wherein the spacer element includes the first tapered portion of the fastening means.

11. The braking assembly of claim 10, further comprising at least two disc springs configured to be placed between the head of the bolt and the at least one spacer element.

12. The braking assembly of claim 8, wherein the fastening means comprises a bolt having a head and a threaded end arranged opposite the head;
the fastening means further comprising a nut arranged to be screwed onto the threaded end, so as to couple the second brake disc to the second side of the wheel, wherein the nut includes the second tapered portion of the fastening means.

13. The braking assembly of claim 8, wherein the fastening means comprises a bolt having a head and a threaded end arranged opposite the head;
the fastening means further comprising a nut arranged to be screwed onto the threaded end, so as to couple the second brake disc to the second side of the wheel, and at least a second spacer element arranged to be placed between the nut and the second flared inner portion of the second brake disc,
wherein the at least one second spacer element includes the second tapered portion of the fastening means.

14. The braking assembly of claim 13, further comprising at least two disc springs configured to be placed between the nut and the at least one second spacer element.

15. A braking assembly for a railway wheel comprising:
a first brake disc arranged to be coupled to a first side of the wheel and defining a first through-hole along an axis parallel to a central axis of the first brake disc, the first through-hole having a first flared inner portion;
a second brake disc arranged to be coupled to a second side of the wheel and defining a second through-hole along an axis parallel to a central axis of the second brake disc, the second through-hole having a second flared inner portion;
a bolt assembly having a first tapered portion complementary to the first flared inner portion and arranged to abut against the first flared inner portion when the first brake disc is coupled to the wheel; and
a nut having a second tapered portion complementary to the second flared inner portion and arranged to abut the second flared inner portion when the second brake disc is coupled to the wheel, wherein the nut is configured to engage a threaded end of the bolt assembly to affix the first and second brake discs to the wheel.

16. The braking assembly of claim 15, wherein the bolt assembly comprises an intermediate portion extending between the first tapered portion and the second tapered portion, and wherein the intermediate portion is arranged to be accommodated in a through-hole defined by the wheel when the first brake disc is coupled to the first side of the wheel and/or the second brake disc is coupled to the second side of the wheel.

17. The braking assembly of claim 16, wherein the through-hole of the wheel, the first through-hole, and the second through-hole are concentric.

18. The braking assembly of claim 15, wherein the bolt assembly includes a bolt having a head, the head including the first tapered portion.

19. The braking assembly of claim 15, wherein the bolt assembly comprises a bolt and a spacer element having the first tapered portion, and wherein the spacer element is configured to be positioned between a head of the bolt and the first flared inner portion of the first brake disc.

20. A vehicle comprising the braking assembly and the railway wheel of claim 15, wherein the braking assembly is attached to the railway wheel.
